(19) United States
(12) Patent Application Publication
(10) Pub. No.: US 2014/0078144 A1
(43) Pub. Date: Mar. 20, 2014

(54) SYSTEMS AND METHODS FOR AVATAR CREATION

(71) Applicant: Squee, Inc., Brookline, MA (US)

(72) Inventors: James Berriman, Brookline, MA (US); Andrew Zupko, Huntsville, AL (US)

(73) Assignee: SQUEE, INC., Brookline, MA (US)

(21) Appl. No.: 14/028,189

(22) Filed: Sep. 16, 2013

Related U.S. Application Data
(60) Provisional application No. 61/701,498, filed on Sep. 14, 2012.

(51) Int. Cl. G06T 13/40; G06F 3/0481; G06F 3/0484

(52) U.S. Cl. CPC G06T 13/40; G06F 3/04847; G06F 3/04817
USPC 345/426; 345/419

(57) ABSTRACT

Systems and methods for modifying an avatar are provided. A user interface including a plurality of modification controls is rendered for display. A modification of a skeletal level of the avatar is received from a user input device, and it is implemented based on a blend shaping technique. An updated display of the avatar is generated.

### CROSS-REFERENCE TO RELATED APPLICATION

This application claims the benefit of U.S. Provisional Application No. 61/701,498 filed Sep. 14, 2012 entitled AVATAR CREATION SYSTEMS AND METHODS, the content of which is incorporated herein in its entirety by reference.

### TECHNICAL FIELD

The present disclosure generally relates to games and applications, and in particular to computer-implemented games having an avatar.

### BACKGROUND

Avatars are commonly used in computer gaming but users also represent themselves through avatars in other applications such as social networking web sites and the Internet and wireless communications applications. There are many computer-implemented games and applications that use avatars as game pieces to navigate and play the game. An avatar is generally a virtual representation of a real-world object such as an animal or a person. Most games utilize two-dimensional avatars, and few games use three-dimensional avatars. The avatar's animation in a computer system uses computational processes applied to data structures. Players of the games can customize their avatar to their preference. Altering an avatar often involves making changes to its data but can also involve changing the data structures. Changes to the avatar can affect the animation computational processes and therefore can complicate the animation of the avatar.

### BRIEF DESCRIPTION OF THE DRAWINGS

FIG. 1 illustrates an example system for implementing a game, according to an example embodiment;

FIGS. 2-2A illustrate example components of a game networking system, according to an example embodiment;

FIGS. 3-3A are flow charts illustrating an example method for creating and modifying an avatar, according to an example embodiment;

FIG. 4 illustrates an example data structure for storing an avatar, according to an example embodiment;

FIG. 5 illustrates an example user interface for creating and modifying an avatar, according to an example embodiment;

FIG. 6 illustrates an example user interface for creating and modifying an avatar, according to an example embodiment;

FIG. 7 illustrates an example user interface for creating and modifying an avatar, according to an example embodiment;

FIG. 8 illustrates an example user interface for creating and modifying an avatar, according to an example embodiment;

FIG. 9 illustrates an example user interface for creating and modifying an avatar, according to an example embodiment;

FIG. 10 illustrates an example user interface for creating and modifying an avatar, according to an example embodiment;

FIG. 11 illustrates an example data flow between example components of the example system of FIG. 1, according to an example embodiment;

FIG. 12 illustrates an example network environment in which various example embodiments may operate, according to an example embodiment;

FIG. 13 illustrates an example computing system architecture, which may be used to implement one or more of the methodologies described herein, according to an example embodiment.

### DESCRIPTION

The systems and methods described herein provide a user with the ability to create a highly-customizable three-dimensional avatar. The user is allowed to modify each element of the avatar (the various body parts) on a continuum by way of various graphical user interface elements, for example, sliders and other variable inputs. In some embodiments, the user is presented with a template avatar that the user can modify using various modification controls. The modified avatar is saved and available for use in various games and applications. In some embodiments, the user is able to modify the avatar within the game or application. The modification of the avatar is seamless and occurs at the same time as the user is inputting the changes via the modification controls. While the user is modifying the avatar, the systems and methods maintain the 3-D animation of the avatar. The animation and modification processes include skeletal manipulation, blend shaping techniques, casting and shading techniques, and additive animation techniques. The data structure for the avatar is formed using a collection of data nodes, each node representing a different part of the avatar.

The template avatars are based on an avatar type that may include, but are not limited to, a person, an animal, a bird, an extraterrestrial creature, and the like. These avatar types may further include more specific types, for example, an animal may include a dog, a cat, a bear, a lion, a snake, a turtle, a hamster, and the like. An extraterrestrial creature may include an alien from a planet other than Earth. In some embodiments, the avatar types may reflect animals that are generally known to be kept as pets by users.

The user can modify various parts of the avatar, including the size and shape of body, head, ears, tail, and the like where applicable. The user can further customize the avatar's skin or outer surface by adding color, patterns, spots, and decals. Decals are tattoo-like or stamp-like images that can be imprinted on the outer surface of an avatar. The customizations to the avatar's outer surface are animated using casting and shading techniques to maintain the quality of animation of the 3-D avatar.

The avatar creation engine has enough flexibility to support the user in creating a credible replica of the user's actual pet or the user himself. This ability adds a compelling element of personal interest for the user. It allows the application of skill and care by the user. This makes the avatar creation engine fun and challenging to use. It gives it “repeat play” value because there are so many possible adjustments and options for creativity. Thus, the avatar creation engine is not trivial or boring to a user. It provides a high enough number of permutations to ensure that the avatars tend toward uniqueness. If the number of permutations were limited, there would eventually be many identical avatars, like other games and applications currently available. The avatar creation engine enhances the element of creativity, as compared to other applications that only offer “cookie cutter” virtual avatars. The avatar creation engine, by itself, can be sufficiently interesting that users want to try it many times and share the results with their friends. It provides the initial “hook” to create interest in the site.

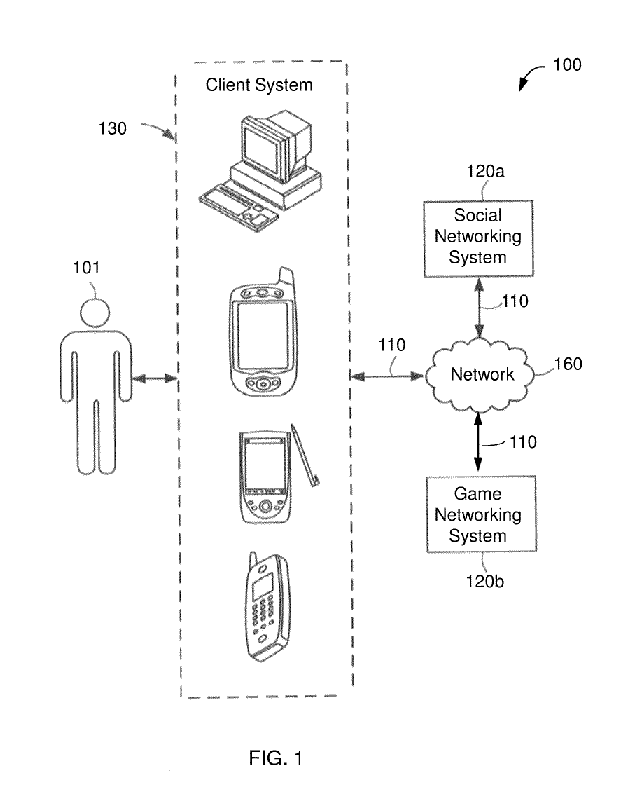

FIG. 1 illustrates an example system for implementing a game, according to an example embodiment. The system 100 can include a user 101, a social network system 120a, a game networking system 120b, a client system 130, and a network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

The user 101 can be a player of a game. The social network system 120a may be a network-addressable computing system that can host one or more social graphs. The social networking system 120a can generate, store, receive, and transmit social networking data. The social network system 120a can be accessed by the other components of system 100 either directly or via network 160. The game networking system 120b is a network-addressable computing system that can host one or more online games. The game networking system 120b can generate, store, receive, and transmit game-related data, such as, for example, game account data, game input, game state data, and game displays. The game networking system 120b can be accessed by the other components of system 100 either directly or via network 160. User 101 may use the client system 130 to access, send data to, and receive data from the social network system 120a and the game networking system 120b.

The client system 130 can access the social networking system 120 and/or the game networking system 120b directly, via network 160, or via a third-party system. In an example embodiment, the client system 130 may access the game networking system 120b via the social networking system 120a. The client system 130 can be any suitable device, such as work stations, computers, general purpose computers, Internet appliances, hand-held devices, wireless devices, portable devices, wearable computers, cellular or mobile phones, portable digital assistants (PDAs), portable navigation systems, vehicle installed navigation systems, smart phones, tablets, ultrabooks, netbooks, laptops, desktops, multi-processor systems, microprocessor-based or programmable consumer electronics, game consoles, set-top boxes, network PCs, mini-computers, smartphones, tablets, and the like.

Although FIG. 1 illustrates a particular number of users 101, social network systems 120a, game networking systems 120b, client systems 130, and networks 160, it should be understood that any suitable number of users 101, social network systems 120a, game networking systems 120b, client systems 130, and networks 160 can be implemented in the system 100. For example, the system 100 may include one or more game networking systems 120b and no social networking systems 120a. As another example, the system 100 may include a system that comprises both the social networking system 120a and the game networking system 120b. Moreover, although FIG. 1 illustrates a particular arrangement of the user 101, the social network system 120a, the game networking system 120b, the client system 130, and the network 160, it should be understood that any suitable arrangement of user 101, social network system 120a, game networking system 120b, client system 130, and network 160 can be implemented in the system 100.

The components of the system 100 may be connected to each other using any suitable connections 110. For example, the connections 110 may include a wireline connection (such as, for example, Digital Subscriber Line (DSL) or Data Over Cable Service Interface Specification (DOCSIS)), a wireless connection (such as, for example, Wi-Fi or Worldwide Interoperability for Microwave Access (WiMAX)) or an optical connection (such as, for example, Synchronous Optical Network (SONET) or Synchronous Digital Hierarchy (SDH)). In some embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between the user 101, the social network system 120a, the game networking system 120b, the client system 130, and the network 160, it should be understood that any suitable connections between player 101, social network system 120a, game networking system 120b, client system 130, and network 160 can be implemented in the system 100. For example, the client system 130 may have a direct connection to the social network system 120a or the game networking system 120b, bypassing network 160.

It is to be appreciated that the virtual gameboard for a game may be presented to a player in a variety of manners. In some embodiments, a game user interface associated with one or more computer-implemented games may be provided to a user via a client device of the user. An application user interface associated with one or more computer-implemented applications may also be provided to a user via client device of the user. Although the systems and methods are described below as related to computer-implemented games and game engines, it should be understood that the systems and methods can be implemented with regards to any computer-implemented application and web-based application.

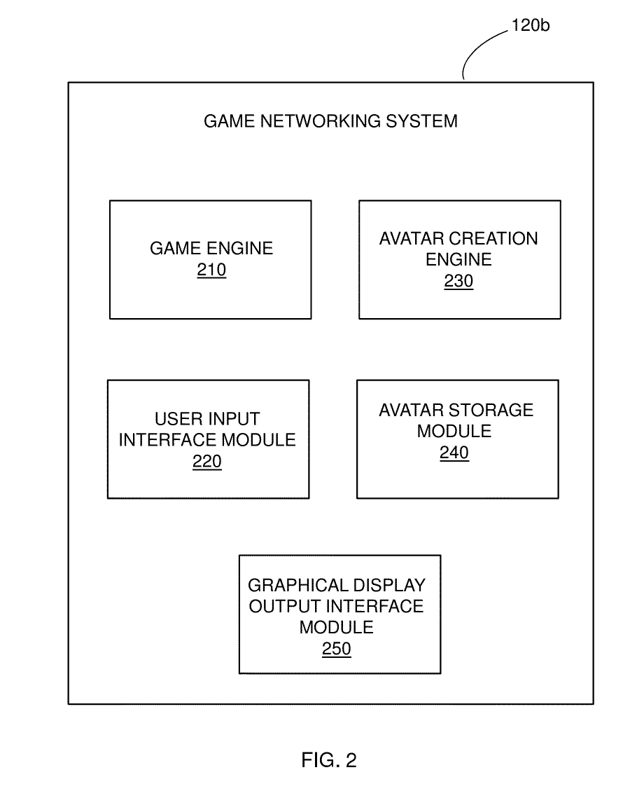

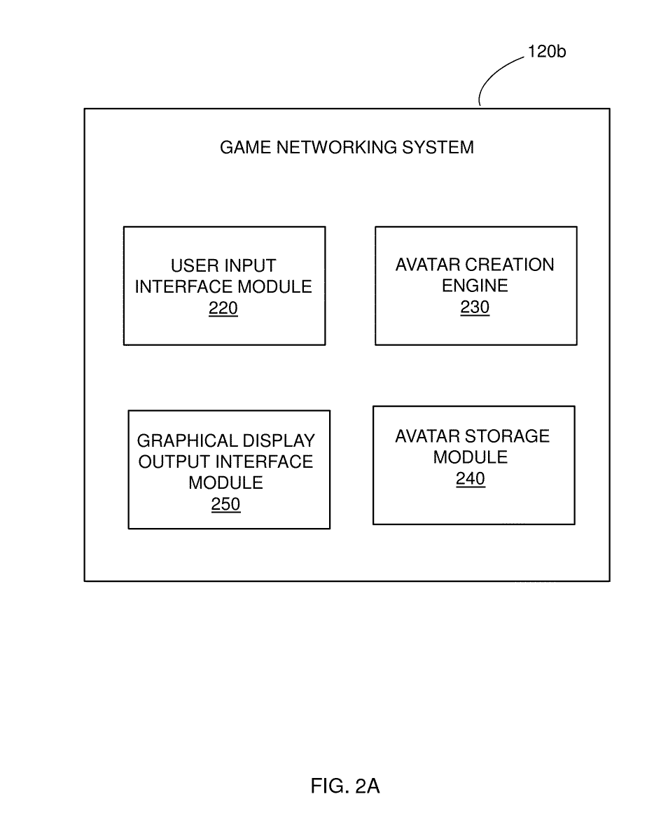

FIG. 2 illustrates example components of a game networking system 120b, according to an example embodiment. The game networking system 120b, as illustrated in FIG. 2, may include a game engine 210, a user input interface module 220, an avatar creation engine 230, an avatar storage module 240, and a graphical display output interface module 250. Although modules 210-250 are illustrated, it should be understood that the game networking system 120b may include fewer or more modules than illustrated. It should be understood that any of the modules 210-250 may communicate with one or more components included in system 100, such as client system 130 and social networking system 120a. FIG. 2A illustrates example components of a game networking system 120b, according to an example embodiment. The game networking system 120b, as illustrated in FIG. 2A may include the user input interface module 220, the avatar creation engine 230, the avatar storage module 240, and the graphical display output interface module 250. In some embodiments, the game networking system 120b includes modules 220-250, while others modules, such as the game engine 210, is included in or hosted by the client system 130. For example, the game engine 210 may be included in or hosted on the client system 130, while the avatar creation engine 230 may be included in the game networking system 120b. Modules 210-250 may be implemented with hardware that is configured to programmatically execute computer readable instructions. For example, modules 210-250 may be implemented in one or more processors with a central processing unit.

The game engine 210 may manage and control any aspects of a game based on rules of the game, including how a game is played, players' actions, responses to players' actions, and the like. The user can use an avatar to play the game by moving the avatar in the game interface and entering user input via the avatar. The game engine 210 may be configured to generate a game instance of the game for a player using the avatar as the game piece, and may determine the progression of a game based on the user inputs and rules of the game.

The user input interface module 220 may receive user inputs for processing by the game engine 210 and the avatar creation engine 230. For example, the user input interface module 220 may receive user inputs indicating functions such as, moving an avatar associated with the user, performing game tasks or quests via an avatar, and the like. These user inputs may be processed by the game engine 210. The user may input game moves or actions by manipulating an avatar. The user input interface module 220 may also receive user inputs regarding creation and modification of an avatar. These user inputs may be processed by the avatar creation engine 230, and may include functions such as, selecting a template avatar, modifying various body parts of the avatar, modifying color and patterns of the avatar, modifying clothing of the avatar, saving the avatar, and the like. The user inputs regarding creating and modifying the avatar may be received via graphical user interface elements, such as sliders and controls, displayed on the game user interface.

The avatar creation engine 230 may process user inputs regarding creation and modification of an avatar. The avatar engine 230, for example, may modify various parts of an avatar and update the avatar in a database and for display. The avatar creation engine 230 may modify the avatar based on modification rules and animation techniques described herein. The avatar creation engine 230 outputs an updated avatar based on the modification indicated by user inputs.

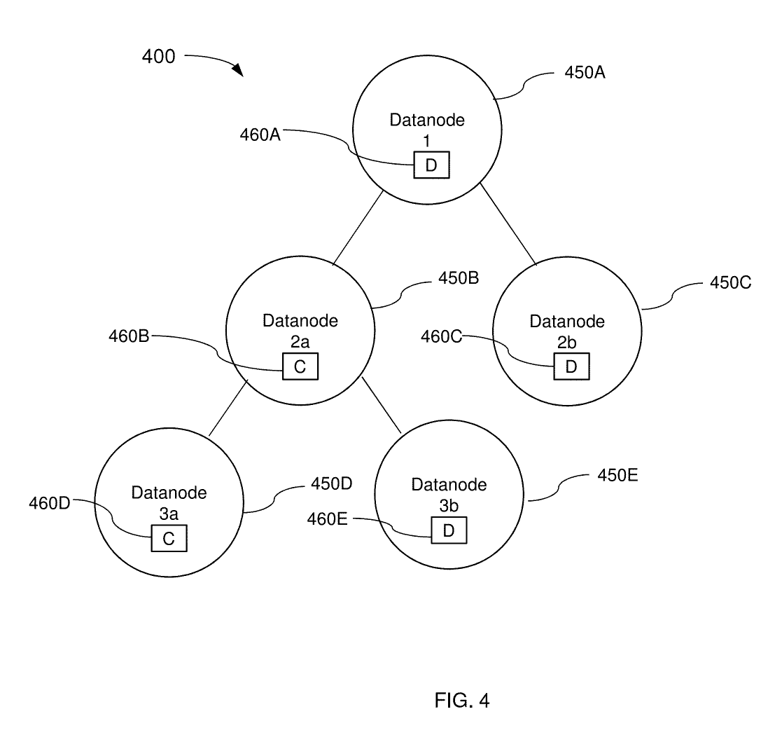

The avatar storage module 240 may store and update an avatar data structure associated with an avatar. The data structure for an avatar may consist of a collection of data nodes, as illustrated in FIG. 4, where each node represents a different part of the avatar. The avatar storage module 240 may update the data nodes based on user input received by the user input interface module 220 and processed by the avatar creation engine 230.

The graphical display output interface module 250 may control information or data that is provided to client systems for display on a client device. For example, the graphical display output interface module 250 may be configured to provide display data associated with displaying a game instance of a game, displaying a game user interface associated with one or more games, displaying an avatar associated with a player in a game user interface, displaying game moves of a player, and the like. The graphical display output interface module 250 may also be configured to update the display of the avatar based on user inputs regarding modifications of the avatar.

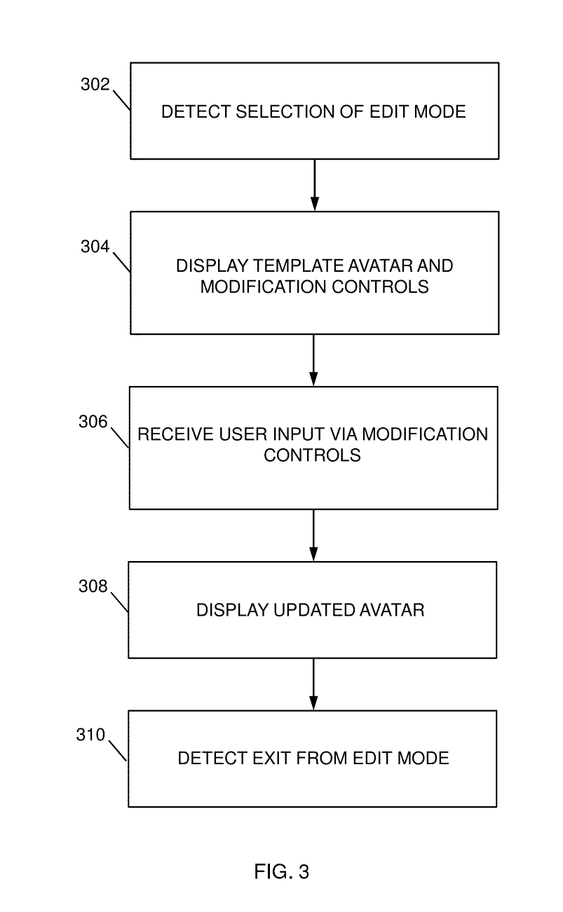

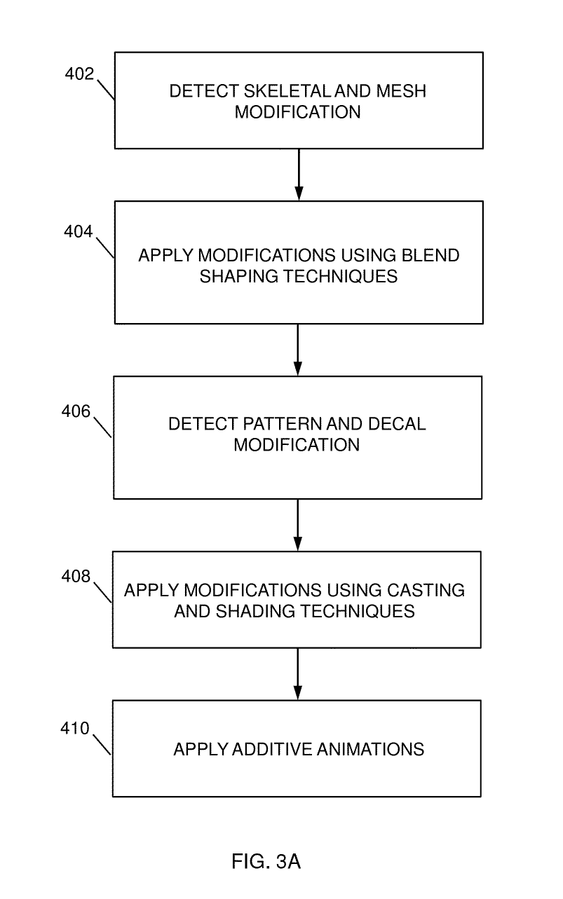

FIG. 3 is a flow chart illustrating an example method 300 for creating and modifying an avatar, according to an example embodiment. In some embodiments, the method 300 may be performed using the game networking system 120b shown in FIG. 1 and FIG. 2.

The first time a user logs into a game, the game interface may display a template avatar for the user to manipulate. In one embodiment, the template avatar may be preselected by the game engine 210 based on the type of game. For example, if the game is related to pets, then the template avatar may be of a dog or a cat. If the game is related to alien invasion, then the template avatar may be of an alien or a human person. In another embodiment, the user may select the template avatar before logging into the game.

If it is not the first time the user is logging into the game, the avatar last-saved by the user is displayed in the game interface. For discussion purposes, the template avatar refers to both a basic template avatar (provided by the game engine 210 or the avatar creation engine 220) and a user's last-saved avatar.

In operation 302, the user input interface module 220 receives user input from a client input device indicating selection of an edit mode for an avatar. A client input device can be any device that a user can use to enter input, such as, a mouse, keyboard, a touch screen, and the like. The user can use his finger or an input pen on a touch screen client input device to enter user input. The user can click on a menu bar within the game interface to select the edit mode. In an example embodiment, selecting the edit mode opens a separate window from the game interface in which the user can edit the avatar. The separate edit window may display the template avatar so that the user can view the changes as they are made. In another embodiment, selecting the edit mode displays a window within the game interface where the user can edit the avatar. The window within the game interface may include the template avatar so that the user can view the changes as they are made. In an alternative embodiment, the edit mode may display a window with edit options within the game interface and not display the template avatar. The avatar is continued to be displayed in the game interface, and the user can view the changes occurring to the avatar within the game interface itself.

In operation 304, the avatar creation engine 230 displays the template avatar and/or modification controls in an edit user interface on the client device. The modification controls may include slider controls, where the user can slide a bar to make changes on a continuum, or any other suitable graphical user interface elements. The modification controls may also include drop down menus and radio buttons. In some embodiments, the mouse pointer may change to a paint brush or another icon to represent a paint modification control. The edit user interface can also include zoom and rotate controls which can be used to manipulate the view of the avatar. The edit user interface can also include a reset button which may undo all the changes and display the template avatar. The user may also add clothing to the avatar. For example, the edit user interface may display a variety of clothing options, such as, shirts, hats, pants, shoes, and the like. These options may be presented to the user as an icon that the user can select or click on to apply to the avatar. The user may also change the color of the clothing. Like clothing, the user can also add accessories to the avatar, such as jewelry, moustaches, beards, glasses, and the like. Some of the modification options may require the user to pay real currency or virtual currency (for example in-game currency) to use the option.

The edit user interface may include various tabs or sections that contain a group of controls relating to a particular type of change. For example, one of the tabs may be labeled “body” which may include modification controls for limbs, spine, tail, etc. Another tab may be labeled “paint” which may include modification controls for skin color, patterns, decals, etc. In some embodiments, the user can change the type of avatar depending on the game rules. For example, if the template avatar is a dog, the user can select a cat as the template avatar. In another example embodiment, the user can select a specific species or breed within the type of avatar where applicable. For example, if the type of avatar is a dog, then the user can select a Saint Bernard template or a Grey Hound template to apply changes.

In an embodiment where the avatar type is not known (because the user did not select one or the game did not determine one) before the user selects the edit mode, the edit user interface displays modification controls, such as sliders, radio buttons, and the like, without any labels or names for the controls. This is the case because the avatar type dictates the names and labels for the modification controls. For example, if the avatar type is a dog, then the modification controls includes controls for ears, nose, fur, and the like. However, if the avatar type is a duck, then the modification controls would include controls for a beak, wings, feathers, and the like. Similarly, if the avatar type is human, then the modification controls would include controls for hands, legs, hair, and the like. Thus, the modification controls are dictated by the type of avatar.

In operation 306, the user input interface module 220 receives user input from client device indicating modification of the avatar. The user can use the modification controls displayed in the edit user interface to modify the avatar. The user may use his mouse or keyboard to indicate changes via the modification controls. For example, the user can use the mouse to move a slider on a slider control to change the size or length of a part of the avatar. The user may also use the arrow keys on the keyboard to move the slider. The user can also select and deselect radio buttons and icons.

In operation 308, the graphical display output interface module 250 displays the updated avatar. In one embodiment, the avatar display is updated in response to receiving the user input via modification controls, that is the avatar is updated on the user interface at substantially the same time user input is received. In this case, the user can view the changes to the avatar as he is using the modification controls. For example, the user can move a slider control corresponding to an ear length, and see the length of the avatar's ear change while moving the slider. In an alternative embodiment, the edit user interface may include an apply button, and the avatar display is updated once the user selects the apply button.

In an example embodiment, the avatar storage module 240 stores an avatar in memory as a data structure consisting of multiple data nodes, where the data nodes correspond to various parts of the avatar. Each modification control tracks its corresponding data node, and updates the data node when a property of the data node is modified. Whenever a modification control is used to input a change, the corresponding data node is modified and flagged as “dirty.” The graphical display output interface module 250 detects the “dirty” nodes and updates the corresponding part of the avatar display. For example, when the user changes the ears of the avatar using the ear modification control, the data node corresponding to the ears are flagged as dirty. The avatar creation engine 230 detects the dirty ear node and updates the ears on the displayed avatar to reflect the change inputted by the user. After updating the display, the ear node is flagged as “clean.” The ear shape is not updated again until another change flags the ear node dirty. This technique saves computational overhead so that the data nodes that do not need updating are not updated.

In an example embodiment, each node comprises a tag that is toggled to flag nodes as dirty or clean. FIG. 4 illustrates an example data structure 400 for storing an avatar, according to an example embodiment. Data structure 400 includes data nodes 450A-450E and tags 460A-460E associated with each data node 450A-450E respectively. As shown in FIG. 4, each tag 460A-460E can be toggled, for example a selected bit in a field may be set or not to represent either a “clean” or “dirty” data node. For example, tag 460A associated with data node 450A is “D”, tag 460B associated with data node 450B is “C”, tag 460C associated with data node 450C is “D”, tag 460D associated with data node 450D is “C”, and tag 460E associated with data node 450E is “D”. Furthermore, data structure 400 may have a parent node and corresponding child and grandchild nodes based on the avatar part represented by the parent node. FIG. 4 shows data node 450A is a parent node, data nodes 450B-450C are child nodes of data node 450A, and data nodes 450D-450E are grandchild nodes of data node 450A. Data node 450A may correspond to, for example, a modification control for a leg of the avatar, while data nodes 450B and 450C may correspond to a lower leg and upper leg respectively. Data nodes 450D and 450E may correspond to knee and feet. In this manner, the parent node corresponds to the highest level of a part of the avatar, and the child nodes correspond to parts connected to the parent part. Even though only data nodes 450A-450E and tags 460A-460E are shown, it is should be understood that data structure 400 may include more or fewer number of data nodes and tags than illustrated.

In operation 310, the game engine 210 detects that the user has exited the edit mode. The game engine 210, at this point, closes the edit user interface and returns the user to the game. The game resumes with the updated avatar. In some embodiments, the user may be returned to the position and level in the game where the user selected the edit mode. In other embodiments where the avatar is updated within the game interface itself and is not displayed in the edit user interface, the game engine 210 merely closes the edit user interface to reveal the game interface with the updated avatar. In this case, the avatar remains at the same position in the game interface during modifications. In some games, the user may receive points or may complete a quest or task by modifying the avatar.

FIG. 4 is a flow chart illustrating an example method 400 for creating and modifying an avatar, according to an example embodiment. In some embodiments, the method can be performed using the avatar creation engine 230.

In an example embodiment, an avatar is represented in two parts: a surface representation used to draw the character (referred to as the “skin” or “mesh”) and a hierarchical set of interconnected bones (referred to as the “skeleton” or “rig”). The set of bones are used to animate the mesh. The avatar creation engine 230 constructs a series of bones that make up the skeleton. Each bone may have a three-dimensional modification (which includes its position, scale and orientation), and often an optional parent bone. The full modification of a child bone is the product of its parent modification and its own modifications. Thus, for example, moving a thigh-bone also moves the lower leg.

In operation 402, the avatar creation engine 230 detects skeletal and mesh modifications of the avatar. For example, the user input interface module 220 may receive a user input that modifies the avatar's limbs, and the avatar creation engine 230 may process that user input and modify the avatar's skeletal (bone) structure according to some modification rules. The skeletal structure of an avatar consists of bones and joints, and modifying one bone may result in an automatic modification of another corresponding bone or joint. Furthermore, as discussed modifying one part of the avatar may automatically modify another part of the avatar. For example, modifying the head size automatically modifies the spacing between eyes. Modifying the head size may also modify the mouth size and nose size proportionally to the change in head size. The avatar creation engine 230 modifies the avatar in accordance with such rules.

Each bone in the skeleton is associated with some portion of the character's visual representation. Skinning is the process of creating this association. In the most common case of a polygonal mesh character, the bone is associated with a group of vertices; for example, in a model of a human being, the ‘thigh’ bone would be associated with the vertices making up the polygons in the model's thigh. Portions of the character's skin can be associated with multiple bones, each one having a scaling factor called vertex weights, or blend weights. The movement of skin near the joints of two bones, can therefore be influenced by both bones. For a polygonal mesh, each vertex can have a blend weight for each bone. To calculate the final position of the vertex, each bone transformation is applied to the vertex position, scaled by its corresponding weight. This algorithm is called matrix palette skinning, because the set of bone transformations (stored as transform matrices) form a palette for the skin vertex to choose from.

The avatar creation engine 230 detects the user input indicating modification of a part of the avatar that is included in the avatar's skeleton. The avatar creation engine 230 applies these changes to the skeleton and updates the skin accordingly. For example, lengthening a leg bone necessarily requires lengthening of the skin covering the bone. Upon detecting such a modification, the avatar creation engine 230 updates both the skeleton and the surface “skin” of the avatar.

In operation 404, the avatar creation engine 230 applies the modifications to the avatar using blend shaping techniques. Blend shaping is a method of 3-D computer animation used with techniques such as skeletal animation. In a blend shaping, a “deformed” version of a mesh is stored as a series of vertex positions. In each key frame of an animation, the vertices are then interpolated between these stored positions. The surface skin or mesh of the avatar may be updated using blend shaping techniques as described herein. In some embodiments, the avatar consists of an original mesh made up of a collection of points or vertices. The avatar further consists of a second mesh that is a version of the original mesh but has a different position or is in a different shape. The second mesh maps to the original mesh at the vertices and accordingly is combined or “blended” with the original mesh to distort the original mesh into the new position or shape. In an example embodiment, the blend shaping module 320 uses smooth and continuous blending in order to accomplish smooth transition between the original avatar and the customized avatar. The end state of the customized avatar is matched to the initial state to make an animatable customized avatar. In an alternative embodiment, the end state may be matched to a different animation understructure, for example, one that matches a state right before the end state.

In operation 406, the avatar creation engine 230 detects pattern and decal modifications of the avatar. The user can modify the avatar by applying or modifying a pattern on the avatar's outer surface. The user can further apply a decal (a tattoo-like or stamp-like image) to the avatar's outer surface. The avatar creation engine 230 detects and prepares to apply such modifications to the avatar. This type of modification requires special attention because such modifications are applied and displayed on the avatar depending on the user's view point. User input is tracked by the avatar creation engine 230 in two ways: 1) physics based ray casting against basic shape colliders (such as spheres, capsules, and boxes); and 2) a shader method which renders the avatar's position into screen coordinates and tests it against the current mouse position of the user. Ray casting includes determining the first object intersected by a ray in order to render a three-dimensional object in two dimensions by following rays of light from the eye of an observer to a light source. The colliders are built into the avatar to provide collision detection. A shader is a type of rendering application within the field of computer graphics. A shader is a computer program often executed on a graphical processor unit (GPU) to affect the appearance of an object on a display. Additionally, camera objects are used as a point of reference to help render the avatar for the user's view. The camera renders a replacement shader which renders any part of the avatar with specific shader tags using the replacement. For example, when the camera is first rendered, some of the shaders are tagged. When the camera is rendered again, the tagged shaders are replaced with a replacement shader. The replacement shader writes the depth and normal information into a full screen texture. The mouse position is determined against the full screen texture to determine where the mouse is clicking within the 3-D space.

In operation 408, the avatar creation engine 230 applies the modifications using casting and shading techniques. In an example embodiment, the avatar creation engine 230 determines a “camera” angle on which to base the user view point for shading purposes. The camera serves as an object through which to view the other objects of the scene. More than one camera can be used. The avatar creation engine 230 further uses UV texture mapping to apply modifications. UV texture mapping is a method for adding detail, surface texture (a bitmap or raster image), or color to a computer-generated graphic or 3-D model. UV mapping projects a texture map onto a 3-D object. The letters “U” and “V” denote the axes of the 2-D texture because “X”, “Y” and “Z” are already used to denote the axes of the 3-D object in model space. UV texturing permits polygons that make up a 3-D object to be painted with color from an image. The image is called a UV texture map, but in some embodiments it is just an ordinary image. The UV mapping process involves assigning pixels in the image to surface mappings on the polygon, usually done by “programmatically” copying a triangle shaped piece of the image map and pasting it onto a triangle on the object. UV is the alternative to XY—it only maps into a texture space rather than the geometric space of the object.

When a model is created as a polygon mesh using a 3-D modeler, UV coordinates can be generated for each vertex in the mesh. In one embodiment, the 3-D modeler is to unfold the triangle mesh at the seams, automatically laying out the triangles on a flat page. If the mesh is a UV sphere, for example, the modeler may transform it into an equirectangular projection. Once the model is unwrapped, the artist can paint a texture on each triangle individually, using the unwrapped mesh as a template. When the scene is rendered, each triangle maps to the appropriate texture. In some embodiments, the UV map is generated by the avatar creation engine 230.

Upon an occurrence of a selection such as a mouse click on the avatar representation, a duplicate camera of the main camera renders all shaders tagged as ‘UVDetectable’ with the custom UV shader. The first and second cameras serve as objects through which to view the avatar in the modification process. The avatar is drawn with the second camera in the UV space of the avatar and all the values are between 0 and 1 to match the UV space. In an alternative embodiment, a depth normal method is used for UV detection. Instead of rendering UV coordinates into colors, the depth of a pixel form the camera and the normal of the pixel in world space are rendered. The UV space values are used by the casting and shading module 340 to determine placement of patterns and decal on the avatar. The RGB colors from the rendered texture are translated into a distance from the camera and a world-based normal of the mouse click and returns that information to the avatar creation engine 230.

Vertex and fragment (pixel) shaders are further used to accomplish the full effect of casting and shading. Vertex shaders take in datasets (called “vertices”), apply specified operations, and produce a single resulting dataset. Pixel shaders take in interpolated fragment data mapping it to pixel's colors. Multiple colors for each output pixel are often written, a feature known as Multiple Render Targets. Pixel shaders determine (or contribute to the determination of) the color of a pixel.

In an example embodiment, the outer surface of the avatar can be customized on multiple levels including base color tint, base texture, decals, overlay patterns, and 3-D painting. This process is done by creating a “sandwich” of textures which are all rendered into one final texture. The resulting texture is then applied to the final outer surface, and is combined with additive and multiplicative textures for highlights/shadows, as well as a normal map for final details.

In one embodiment, an orthographic compositor tracks a number of 3-D sprites in an ordered stack that is placed in front of an orthographic camera. Each layer can be scaled, rotated, hidden, or tinted. Each piece of the outer surface is given its own layer. The base layer, for example, is always visible. For example, if the avatar type is a dog, then the base layer is the dog's standard coat. When decals are enabled, the decal layer sprite is turned on and is rendered in front of the base layer. Painting and patterns follow the same methodology. Whenever a change is detected in the data structure, the orthographic compositor renders the camera again and the avatar's outer surface updates with the new content.

In another embodiment, projective painting is used to add texture inside the layer, instead of the orthographic compositor. In projective painting, a painting tool is used to hold a render texture for the final output of the avatar projection. When a painting mode is enabled, the avatar creation engine 230 determines the 3-D space location to which the mouse is currently pointing. As described above, the avatar creation engine 230 performs depth normal casting and handles the results. The depth normal cast also determines the direction of the skin normal.

If the user's mouse is over the avatar, a projector is placed a small distance down the normal from the point where the mouse intersects with the avatar in three dimensional space. The projector has a special shader that renders its output into the UV space of the model. The projector renders what it hits into a flattened out texture in UV space. The rendered texture is deformed to fit a flattened avatar texture in UV space. The rendered texture and the avatar texture are then composited and blended onto the avatar model. The process of projecting onto UV space and adding onto the avatar model can continue until a satisfactory texture is achieved. Erasure on the avatar model is accomplished in a similar process.

For decals, the painting render texture is cleared, for regular painting mode, it is not. The new content is rendered on top of the current render texture and is sent to the orthographic layer to be composited.

In operation 410, the avatar creation engine 230 applies additive animations to the avatar display. Additive animations may include additional animation such as, if the avatar is a dog, the dog is animated to shake his head which results in its ears flapping and maybe even his tail wagging. As such, moving one bone or part results in the movement of other bones and parts. Additive animations may also cause automatic modification of one part based on the modification of another part by the user. For example, modifying the head size automatically modifies the spacing between the eyes. Modifying the head size may also modify the mouth size and nose size proportionally to the change in head size. Another example of additive animations comprises adding an additional offset after the main animation plays for each frame. For example, if the regular animation illustrates a bone as 30 degrees, and the additive animation has an offset of 5 degrees, the resulting final animation illustrates the bone at 35 degrees. In some embodiments, this animation is applied while the user is modifying the avatar. In alternative embodiments, this animation is only applied to the avatar during game play.

Even though operation 410 is shown as occurring after operations 402-408, operation 410 can occur at any time during edit mode or game play mode. Additionally, operations 402-408 can occur at any time during edit mode based on the user input. The user may modify decals and pattern of the avatar before modifying the avatar skeleton, in which case, operations 406 and 408 occur before operations 402 and 404. Thus, method 400 is merely an example of the creation and modification process of an avatar.

Furthermore, a user may upload a photograph to assist in the creation of an avatar. For example, if the user wants to create an avatar based on his pet, then the user can upload a picture of his pet. The user is able to input particular data about the pet, such as, pet type, breed, body size, and the like, to assist the avatar creation engine 230 in creating an avatar from the photograph. Using various animation techniques, the avatar creation engine 230 creates an avatar that is based on the photograph. The graphical display output interface 240 displays the avatar along with modification controls that the user can use to modify the generated avatar as discussed above.

In an example embodiment, the user's avatar is saved to a file in JSON format (Java Script Object Notation) as a string. The compositor layers are saved individually including storing rotation, scale, and depth properties. Painted layers are converted to png format and saved into the JSON file as well. When the user's avatar is loaded into the user interface, the data object is unserialized from the JSON and all properties of the avatar object update with any new content.

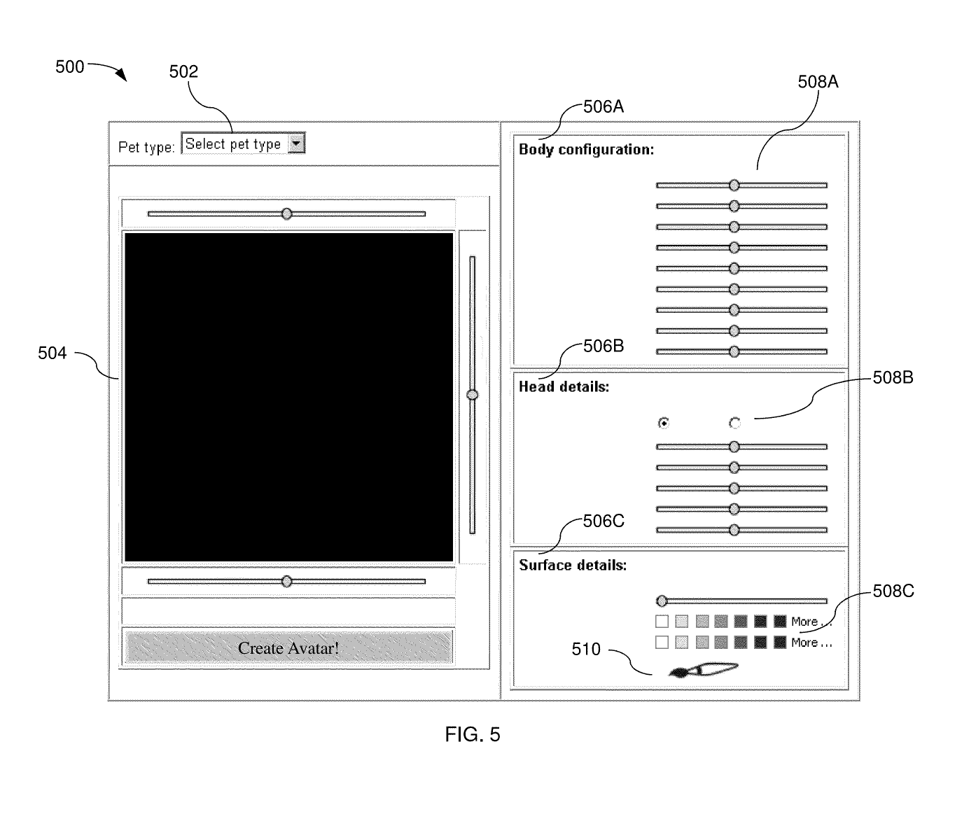

FIG. 5 illustrates an example user interface 500 for creating and modifying an avatar, according to example embodiments. User interface 500 may be displayed when the user selects edit mode to create or modify an avatar. User interface 500 includes drop down menu 502, avatar display window 504, modification categories 506A, 506B, 506C, modification controls 508A, 508B, and paint control 510. The user can select an avatar type from the drop down menu 502 to work with. As discussed above, an avatar type may include a human, any animal, any bird, an alien, and the like. Avatar display window 504 in this embodiment is blank because the user did not select an avatar type before playing the game, and the game engine 210 did not preselect an avatar type for the game. In this example, modification category 506A is labeled “Body configurations,” modification category 506B is labeled “Head details,” and modification category 506C is labeled “Surface details.” As discussed above, modification controls may be grouped into categories such as body configurations, head details, and surface details, as shown in user interface 500. Modification controls 508A are shown as slider controls, 508B are shown as radio buttons, and 508C are shown as color palettes in user interface 500. The modification controls 508A, 508B, 508C are not labeled because an avatar type is not selected. As discussed above, the labeling of the modification controls 508 is dictated by the avatar type, so when an avatar type is not selected the modification controls are not labeled. The color palettes illustrated by modification controls 508C, includes a “More . . . ” option. Selecting the “More . . . ” option displays more colors that the user can choose from. User interface 500 also includes paint control 510 that can be selected to paint on the outer surface of the avatar. Although, user interface 500 shows specific elements arranged in a particular manner and in a particular position, it should be understood that the elements may be arranged in any other manner or position than shown in user interface 500.

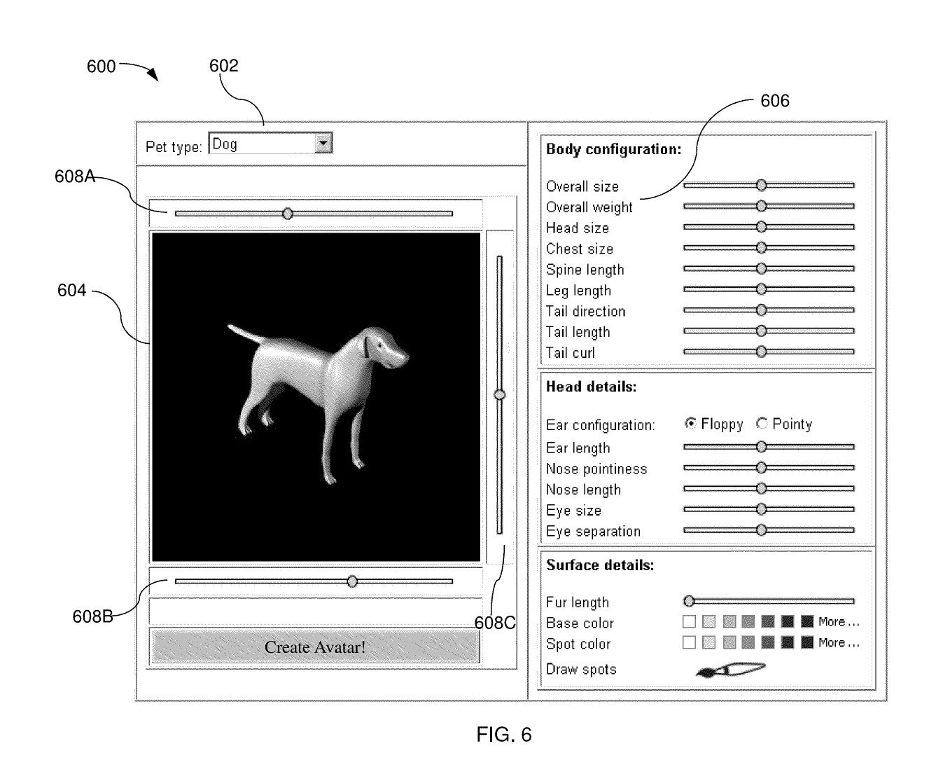

FIG. 6 illustrates an example user interface 600 for creating and modifying an avatar, according to example embodiments. User interface 600 may be displayed when the user selects an avatar type from drop down menu 502 shown in user interface 500 of FIG. 5. User interface 600 may also be displayed if an avatar type is preselected by game engine 210 or by the user before starting the game. User interface 600 includes avatar type 602, avatar display window 604, modification control labels 606, and view controls 608A, 608B, 608C. In this example, the avatar type 602 is “Dog.” The avatar display window 604 shows a template avatar of a dog based on the avatar type 602. The modification control labels 606 are displayed based on the avatar type 602 being “Dog.” Thus, in this example, the modification control labels 606 include labels that may be specific to a “Dog,” such as, “Overall size,” “Overall weight,” “Head size,” “Chest size,” “Spine length,” “Leg length,” “Tail direction,” “Tail length,” “Tail curl,” “Ear configuration,” “Ear length,” “Nose pointiness,” “Nose length,” “Eye size,” “Eye separation,” “Fur length,” “Base color,” “Spot color,” “Draw spots” and the like. User interface 600 also shows view controls 608A, 608B, 608C near the avatar display window 604. The view controls 608A, 608B, 608C can be used by the user to zoom-in and rotate the avatar image. Although, user interface 600 shows specific elements arranged in a particular manner and in a particular position, it should be understood that the elements may be arranged in any other manner or position than shown in user interface 600.

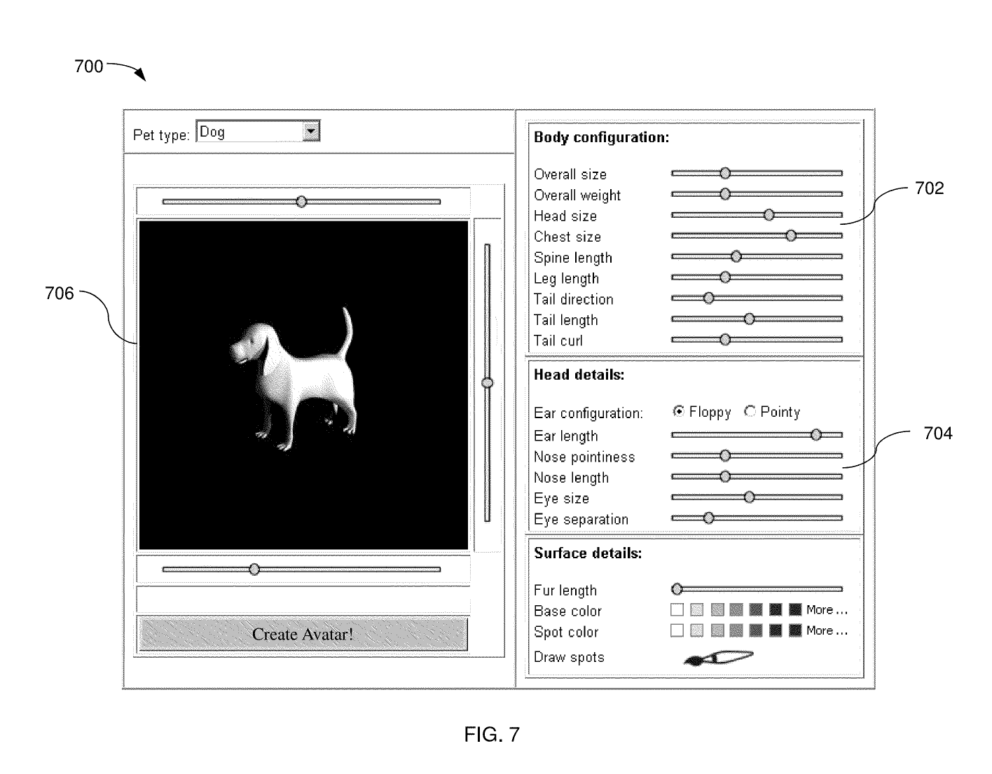

FIG. 7 illustrates an example user interface 700 for creating and modifying an avatar, according to example embodiments. User interface 700 may be displayed in response to the user manipulating the modification controls to make changes to an avatar. User interface 700 includes modification controls 702, modification controls 704, and avatar display window 706. In this example, the user has moved the modification controls 702 and 704 to make changes to the avatar. The avatar display 706 reflects the changes corresponding to modification controls 702 and 704. For example, the user increased the “Chest size” and decreased the “Spine length” as illustrated by modification controls 702. The user also increased the “Ear length” as illustrated by modification controls 704. The avatar display window 706 shows a dog with larger chest, shorter spine, and longer ears, compared to template avatar shown in the avatar display window 604 of user interface 600. As discussed above, the changes are reflected in the avatar display window 706 as the modification controls 702 and 704 are manipulated. The system and methods described herein facilitate the seamless display of the changes in the avatar. Although, user interface 700 shows specific elements arranged in a particular manner and in a particular position, it should be understood that the elements may be arranged in any other manner or position than shown in user interface 700.

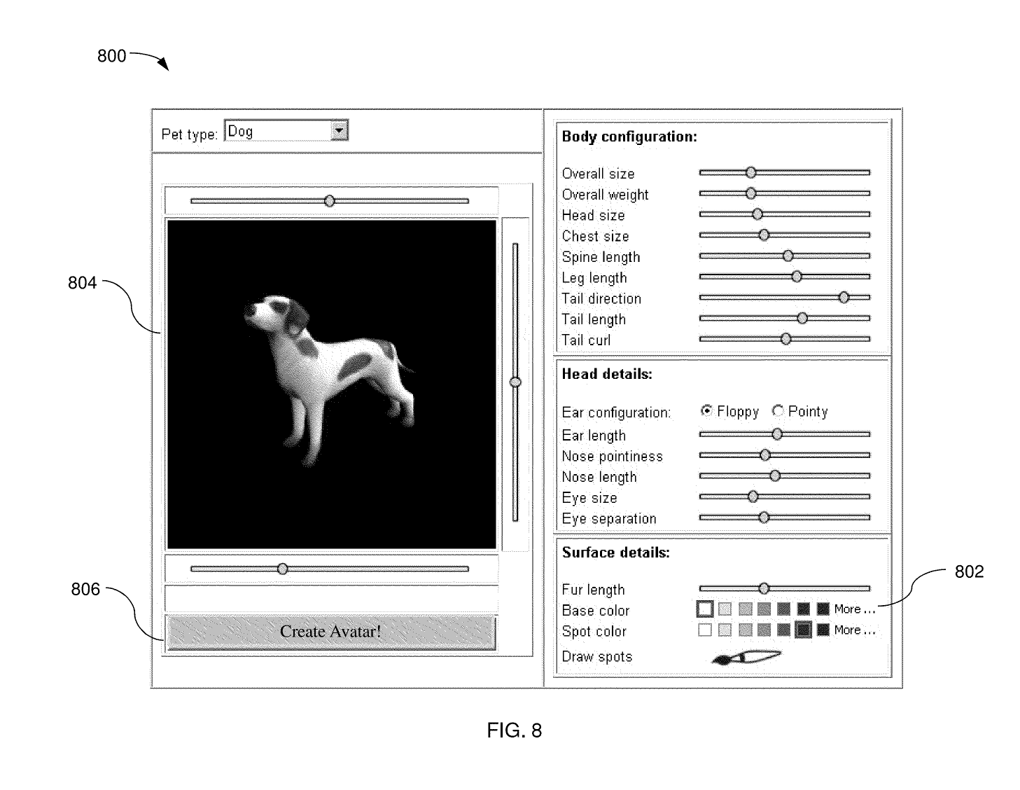

FIG. 8 illustrates an example user interface 800 for creating and modifying an avatar, according to example embodiments. User interface 800 may be displayed in response to the user applying paint modifications to the avatar. User interface 800 includes modification controls 802, avatar display 804, and button 806. In this example, the user used modification controls 802 to paint the skin of the dog. Modification controls 802 includes color palettes for base color and spot color, and a paint brush that can be used to draw spots on the dog. The avatar display 804 shows the dog with the updated color and spots. The user can select button 806 to save the avatar. In some embodiments, selecting button 806 returns the user to the game with the updated avatar. Although, user interface 800 shows specific elements arranged in a particular manner and in a particular position, it should be understood that the elements may be arranged in any other manner or position than shown in user interface 800.

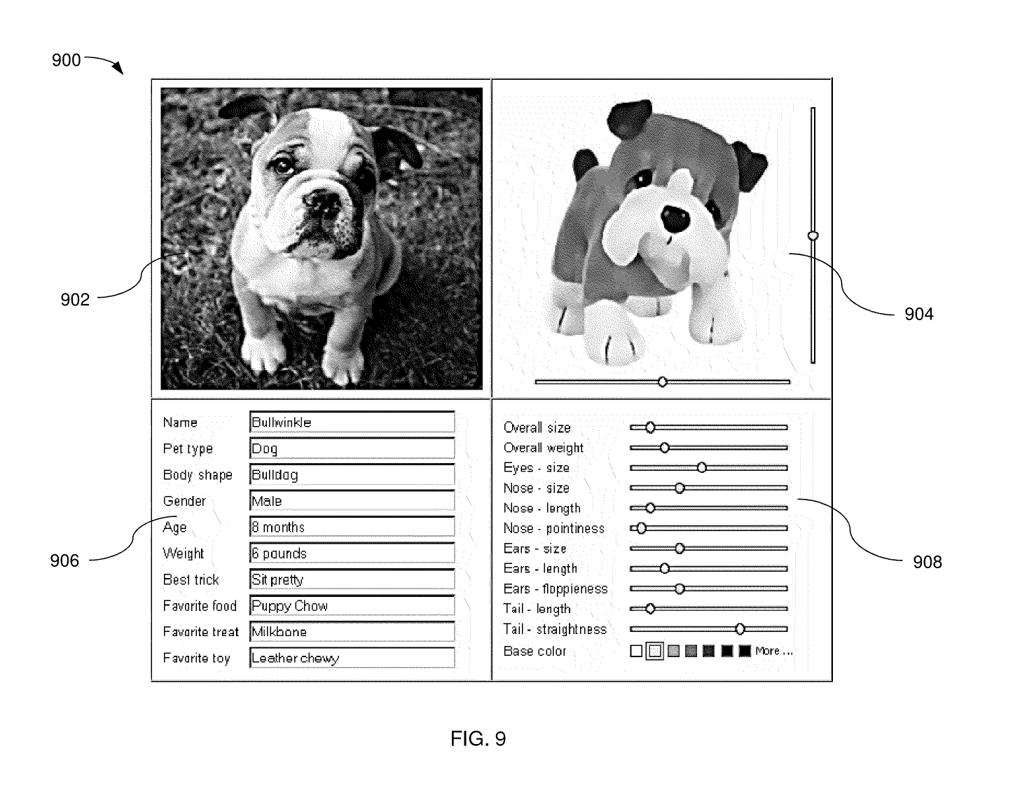

FIG. 9 illustrates an example user interface 900 for creating and modifying an avatar, according to example embodiments. User interface 900 may be displayed when a user uploads a photo to create an avatar from. User interface 900 includes photo 902, avatar 904, photo information 906, and modification controls 908. The photo 902 is uploaded by the user, and the user also enters photo information 906. The avatar creation engine 230 generates an avatar 904 from the photo 902 and the information 906. The user can use modification controls 908 to modify the avatar 904 to his liking. Although, user interface 900 shows specific elements arranged in a particular manner and in a particular position, it should be understood that the elements may be arranged in any other manner or position than shown in user interface 900.

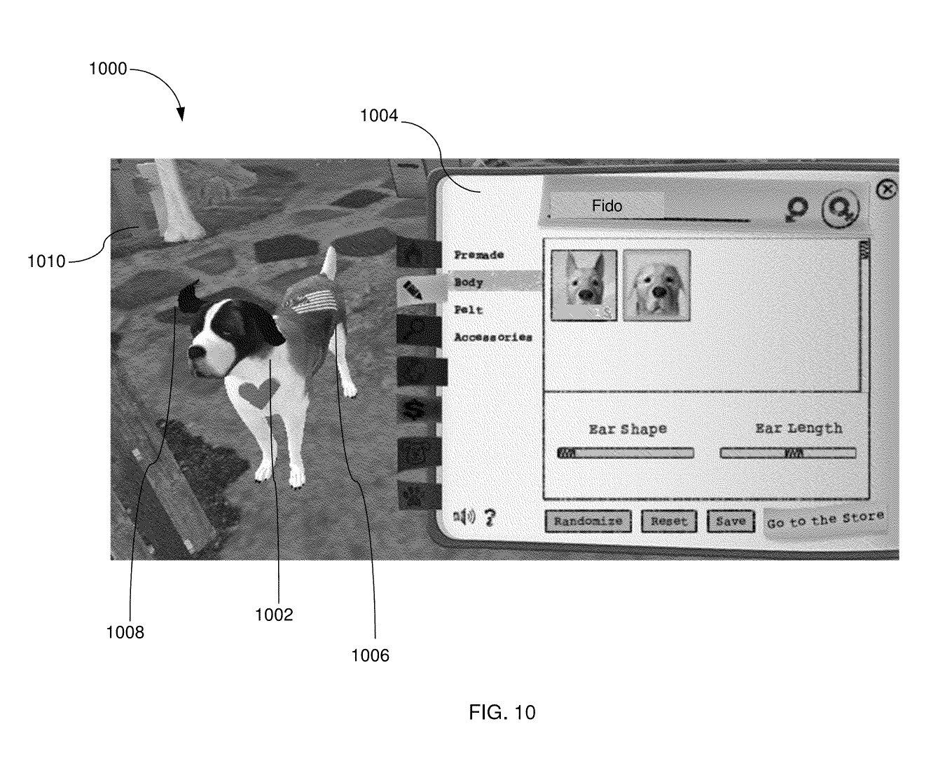

FIG. 10 illustrates an example user interface 1000 for creating and modifying an avatar, according to example embodiments. User interface 1000 may be displayed when the user selects the edit mode within a game. User interface 1000 is an example of an alternative embodiment to user interfaces 700-900 illustrated in FIGS. 7-9. User interface 1000 includes dog avatar 1002, edit mode interface 1004, decal 1006, dog ear 1008, and game interface 1010. In this example, the dog avatar 1002 is displayed in the game interface 1010 instead of edit mode interface 1004, and the changes made by the user is reflected in the dog avatar 1002 while being displayed in game interface 1010. The user, in this example, added the decal 1006 to the skin or pelt of the avatar dog 1002. As discussed above, casting and shading techniques were used to add the decal 1006 so that it appears, to the user, that the decal 1006 is tattooed onto the dog's skin. As seen in user interface 1000, the decal 1006 matches the curvature of the dog's body. Furthermore, additive animations were also applied as illustrated by dog ear 1008. As discussed above, additive animations animates a part of the 3-D avatar based on the animation of other parts. Dog ear 1008 is in mid-air as a result of the dog avatar 1002 shakes his head as a real dog would. When the user exits the edit mode interface 1004, the edit mode interface 1004 simply collapses into a panel on the right edge of the game interface 1010, thus revealing the game interface 1010. Although, user interface 800 shows specific elements arranged in a particular manner and in a particular position, it should be understood that the elements may be arranged in any other manner or position than shown in user interface 800.

In this manner, systems and methods for avatar creation are provided to facilitate creation and modification of a 3-D avatar used within a computer-implemented game or application. The user is able to modify various parts of an avatar including the skeletal structure and the outer surface layer. The avatar creation engine reflects the changes seamlessly while maintaining animation of the avatar. Since, the avatar creation engine is not based on a particular game or application, it can be integrated with other games and applications and allows the user to use the same avatar across multiple applications. The avatar creation engine may be provided as a plug-in to various applications.

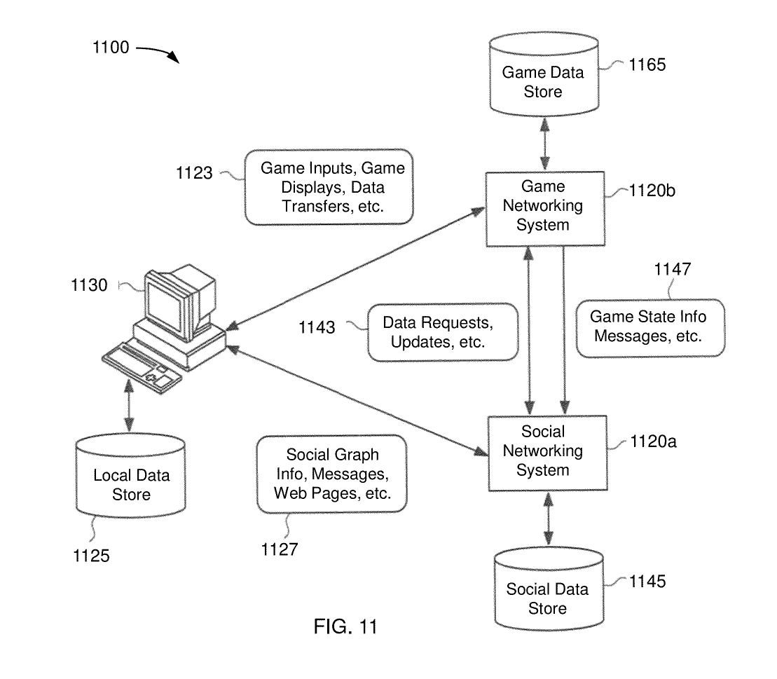

FIG. 11 illustrates an example data flow between example components of the example system of FIG. 1, according to an example embodiment. In an example embodiment, system 1100 can include client system 1130, social networking system 1120a, and game networking system 1120b. The components of system 1100 can be connected to each other in any suitable configuration, using any suitable type of connection. The components may be connected directly or over any suitable network. The client system 1130, the social networking system 1120a, and the game networking system 1120b can each have one or more corresponding data stores such as local data store 1125, social data store 1145, and game data store 1165, respectively. The social networking system 1120a and the game networking system 1120b can also have one or more servers that can communicate with the client system 1130 over an appropriate network. The social networking system 1120a and the game networking system 1120b can have, for example, one or more internet servers for communicating with the client system 1130 via the Internet. Similarly, the social networking system 1120a and the game networking system 1120b can have one or more mobile servers for communicating with the client system 1130 via a mobile network (e.g., GSM, PCS, Wi-Fi, WPAN, etc.). In some embodiments, one server may be able to communicate with the client system 1130 over both the Internet and a mobile network. In other embodiments, separate servers can be used.

The client system 1130 can receive and transmit data 1123 to and from the game networking system 1120b. Data 1123 can include, for example, webpages, messages, game inputs, game displays, rally requests, HTTP packets, data requests, transaction information, updates, and other suitable data. At some other time, or at the same time, the game networking system 1120b can communicate data 1143, 1147 (e.g., game state information, game system account information, page info, messages, data requests, updates, etc.) with other networking systems, such as the social networking system 1120a (e.g., Facebook, Myspace, etc.). The client system 1130 can also receive and transmit data 1127 to and from the social networking system 1120a. Data 1127 can include, for example, webpages, messages, rally requests, social graph information, social network displays, HTTP packets, data requests, transaction information, updates, and other suitable data.

Communication between the client system 1130, the social networking system 1120a, and the game networking system 1120b can occur over any appropriate electronic communication medium or network using any suitable communications protocols. For example, the client system 1130, as well as various servers of the systems described herein, may include Transport Control Protocol/Internet Protocol (TCP/IP) networking stacks to provide for datagram and transport functions. Any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. In some embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In example embodiments, a client request may cause a server to respond with a first data object, such as an HTML page, which itself refers to other data objects. A client application, such as a browser, requests these additional data objects as it parses or otherwise processes the first data object.

In some embodiments, an instance of an online game can be stored as a set of game state parameters that characterize the state of various in-game objects, such as, for example, card parameters, player character state parameters, non-player character parameters, and virtual item parameters. In some embodiments, game state is maintained in a database as a serialized, unstructured string of text data as a so-called Binary Large Object (BLOB). When a player accesses an online game on the game networking system 1120b, the BLOB containing the game state for the instance corresponding to the player can be transmitted to the client system 1130 for use by a client-side executed object to process. In some embodiments, the client-side executable may be a FLASH-based game, which can de-serialize the game state data in the BLOB. As a player plays the game, the game logic implemented at the client system 1130 maintains and modifies the various game state parameters locally. The client-side game logic may also batch game events, such as mouse clicks or screen taps, and transmit these events to the game networking system 1120b. The game networking system 1120b may itself operate by retrieving a copy of the BLOB from a database or an intermediate memory cache (memcache) layer. The game networking system 1120b can also de-serialize the BLOB to resolve the game state parameters and execute its own game logic based on the events in the batch file of events transmitted by the client to synchronize the game state on the server side. The game networking system 1120b may then re-serialize the game state, now modified, into a BLOB and pass this to a memory cache layer for lazy updates to a persistent database.

With a client-server environment in which the online games may run, one server system, such as the game networking system 1120b, may support multiple client systems 1130. At any given time, there may be multiple players at multiple client systems 1130 all playing the same online game. In practice, the number of players playing the same game at the same time may be very large. As the game progresses with each player, multiple players may provide different inputs to the online game at their respective client systems 1130, and multiple client systems 1130 may transmit multiple player inputs and/or game events to the game networking system 1120b for further processing. In addition, multiple client systems 1130 may transmit other types of application data to the game networking system 1120b.

In some embodiments, a computed-implemented game may be a text-based or turn-based game implemented as a series of web pages that are generated after a player selects one or more actions to perform. The web pages may be displayed in a browser client executed on the client system 1130. As an example and not by way of limitation, a client application downloaded to client system 1130 may operate to serve a set of webpages to a player. As another example and not by way of limitation, a computer-implemented game may be an animated or rendered game executable as a stand-alone application or within the context of a webpage or other structured document. In example embodiments, the computer-implemented game may be implemented using Adobe Flash-based technologies. As an example and not by way of limitation, a game may be fully or partially implemented as a SWF object that is embedded in a web page and executable by a Flash media player plug-in. In some embodiments, one or more described webpages may be associated with or accessed by the social networking system 1120a. This disclosure contemplates using any suitable application for the retrieval and rendering of structured documents hosted by any suitable network-addressable resource or website.

Application event data of a game is any data relevant to the game (e.g., player inputs). In some embodiments, each application datum may have a name and a value, and the value of the application datum may change (i.e., be updated) at any time. When an update to an application datum occurs at the client system 1130, caused either by an action of a game player or by the game logic itself, the client system 1130 may need to inform the game networking system 1120b of the update. In such an instance, the application event data may identify an event or action (e.g., harvest) and an object in the game to which the event or action applies. For illustration purposes and not by way of limitation, system 1100 is discussed in reference to updating a multi-player online game hosted on a network-addressable system (such as, for example, the social networking system 1120a or the game networking system 1120b), where an instance of the online game is executed remotely on the client system 1130, which then transmits application event data to the hosting system such that the remote game server synchronizes game state associated with the instance executed by the client system 1130.

In an example embodiment, one or more objects of a game may be represented as an Adobe Flash object. Flash may manipulate vector and raster graphics, and supports bidirectional streaming of audio and video. “Flash” may mean the authoring environment, the player, or the application files. In some embodiments, the client system 1130 may include a Flash client. The Flash client may be configured to receive and run Flash application or game object code from any suitable networking system (such as, for example, the social networking system 1120a or the game networking system 1120b). In some embodiments, the Flash client may be run in a browser client executed on the client system 1130. A player can interact with Flash objects using the client system 1130 and the Flash client. The Flash objects can represent a variety of in-game objects. Thus, the player may perform various in-game actions on various in-game objects by make various changes and updates to the associated Flash objects. In some embodiments, in-game actions can be initiated by clicking or similarly interacting with a Flash object that represents a particular in-game object. For example, a player can interact with a Flash object to use, move, rotate, delete, attack, shoot, or battle an in-game object. This disclosure contemplates performing any suitable in-game action by interacting with any suitable Flash object. In some embodiments, when the player makes a change to a Flash object representing an in-game object, the client-executed game logic may update one or more game state parameters associated with the in-game object. To ensure synchronization between the Flash object shown to the player at the client system 1130, the Flash client may send the events that caused the game state changes to the in-game object to game networking system 1120b. However, to expedite the processing and hence the speed of the overall gaming experience, the Flash client may collect a batch of some number of events or updates into a batch file. The number of events or updates may be determined by the Flash client dynamically or determined by the game networking system 920b based on server loads or other factors. For example, the client system 1130 may send a batch file to the game networking system 1120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In example embodiments, each application datum may have a name and a value. The value of an application datum may change at any time in response to the game play of a player or in response to the game engine (e.g., based on the game logic). In some embodiments, an application data update occurs when the value of a specific application datum is changed. In example embodiments, each application event datum may include an action or event name and a value (such as an object identifier). Each application datum may be represented as a name-value pair in the batch file. The batch file may include a collection of name-value pairs representing the application data that have been updated at client system 930. In some embodiments, the batch file may be a text file and the name-value pairs may be in string format.

In example embodiments, when a player plays an online game on the client system 1130, the game networking system 1120b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In some embodiments, while a player is not playing the online game, the corresponding BLOB may be stored in the database. This enables a player to stop playing the game at any time without losing the current state of the game the player is in. When a player resumes playing the game next time, the game networking system 1120b may retrieve the corresponding BLOB from the database to determine the most-recent values of the game-related data. In example embodiments, while a player is playing the online game, the game networking system 1120b may also load the corresponding BLOB into a memory cache so that the game system may have faster access to the BLOB and the game-related data contained therein.

In example embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

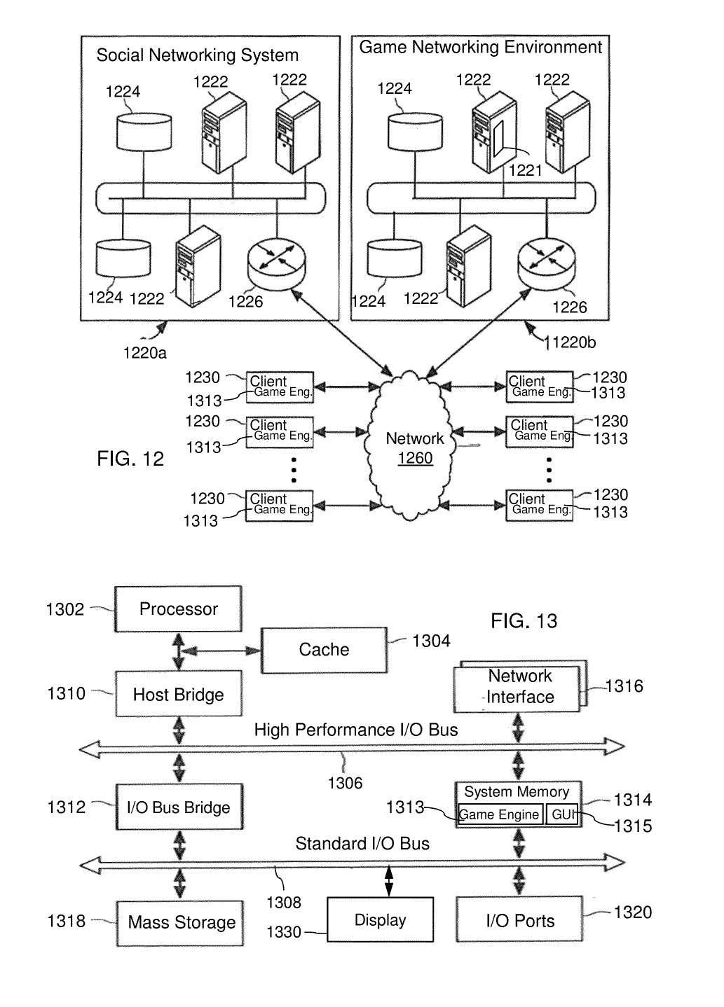

Some embodiments may operate in a wide area network environment, such as the Internet, including multiple network addressable systems. FIG. 12 illustrates an example network environment 1200 in which various example embodiments may operate, according to an example embodiment. Network cloud 1260 generally represents one or more interconnected networks, over which the systems and hosts described herein can communicate. Network cloud 1260 may include packet-based wide area networks (such as the Internet), private networks, wireless networks, satellite networks, cellular networks, paging networks, and the like. As FIG. 13 illustrates, some embodiments may operate in a network environment comprising one or more networking systems, such as the social networking system 1220a, game networking environment 1220b, and one or more client systems 1230 including a game engine 1313. The game engine 1313 may be configured to perform one or more functionalities as described herein. The components of the social networking system 1220a and the game networking environment 1220b operate analogously; as such, hereinafter they may be referred to simply as networking system 1220. The client systems 1230 are operably connected to the network environment via a network service provider, a wireless carrier, or any other suitable means.

The networking system 1220 is a network addressable system that, in various example embodiments, comprises one or more physical servers 1222 and data stores 1224. The one or more physical servers 1222 are operably connected to computer network 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like. In some embodiments, one or more of the physical servers 1222 may include avatar creation engine 1221, where the avatar creation engine may include one or more functionalities described herein.

The physical servers 1222 may host functionality directed to the operations of the networking system 1220. Hereinafter servers 1222 may be referred to as server 1222, although server 1222 may include numerous servers hosting, for example, the networking system 1220, as well as other content distribution servers, data stores, and databases. The data store 1224 may store content and data relating to, and enabling, operation of the networking system 1220 as digital data objects. A data object, in some embodiments, is an item of digital information often stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, the data store 1224 corresponds to one or more of a variety of separate and integrated databases, such as relational databases and object-oriented databases that maintain information as an integrated collection of logically related records or files stored on one or more physical systems. Structurally, the data store 1224 may generally include one or more of a large class of data storage and management systems. In particular embodiments, the data store 1224 may be implemented by any suitable physical system(s) including components, such as one or more database servers, mass storage media, media library systems, storage area networks, data storage clouds, and the like. In one example embodiment, the data store 1224 includes one or more servers, databases (e.g., MySQL), and/or data warehouses. The data store 1224 may include data associated with different networking system 1220 users and/or client systems 1230.

The client system 1230 is generally a computer or computing device including functionality for communicating (e.g., remotely) over a computer network. The client system 1230 may be a desktop computer, laptop computer, personal digital assistant (PDA), in- or out-of-car navigation system, smart phone or other cellular or mobile phone, or mobile gaming device, among other suitable computing devices. The client system 1230 may execute one or more client applications, such as a web browser (e.g., Microsoft Internet Explorer, Mozilla Firefox, Apple Safari, Google Chrome, and Opera), to access and view content over a computer network. In some embodiments, the client applications allow a user of the client system 1030 to enter addresses of specific network resources to be retrieved, such as resources hosted by the networking system 1220. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1230 desires to view a particular webpage (hereinafter also referred to as target structured document) hosted by the networking system 1220, the user's web browser, or other document rendering engine or suitable client application, formulates and transmits a request to the networking system 1220. The request generally includes a URL or other document identifier as well as metadata or other information. By way of example, the request may include information identifying the user, such as a user ID, as well as information identifying or characterizing the web browser or operating system running on the user's client computing device 1230. The request may also include location information identifying a geographic location of the user's client system or a logical network location of the user's client system. The request may also include a timestamp identifying when the request was transmitted.

Although the example network environment described above and illustrated in FIG. 12 described with respect to the social networking system 1220a and the game networking environment 1220b, this disclosure encompasses any suitable network environment using any suitable systems. As an example and not by way of limitation, the network environment 1200 may include online media systems, online reviewing systems, online search engines, online advertising systems, or any combination of two or more such systems.

FIG. 13 illustrates an example computing system architecture 1300, which may be used to implement one or more of the methodologies described herein, according to an example In one embodiment, hardware system 1300 comprises a processor 1302, a cache memory 1304, and one or more executable modules and drivers, stored on a tangible computer readable medium, directed to the functions described herein. Additionally, hardware system 1300 may include a high performance input/output (I/O) bus 1306 and a standard I/O bus 1308. A host bridge 1310 may couple processor 1302 to high performance I/O bus 1306, whereas I/O bus bridge 1312 couples the two buses 1306 and 1308 to each other. A system memory 1314 including a game engine 1313 and a graphical user interface 1315, and one or more network/communication interfaces 1316 may couple to bus 1306. Hardware system 1300 may further include video memory (not shown) and a display device coupled to the video memory. Mass storage 1318 and I/O ports 1320 may couple to bus 1308. Hardware system 1300 may optionally include a keyboard, a pointing device, and a display device 1330 coupled to bus 1308. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1300 are described in greater detail below. In some embodiments, network interface 1316 provides communication between hardware system 1300 and any of a wide range of networks, such as an Ethernet (e.g., IEEE 802.3) network, a backplane, etc. Mass storage 1318 provides permanent storage for the data and programming instructions to perform the above-described functions implemented in servers 1222, whereas system memory 1314 (e.g., DRAM) provides temporary storage for the data and programming instructions when executed by processor 1302, including data and programming instructions associated with game engine 1313 and graphical user interface 1315. I/O ports 1320 are one or more serial and/or parallel communication ports that provide communication between additional peripheral devices, which may be coupled to hardware system 1300. Display 1330 is one or more devices that may display a user interface for the user to view and to use and interact with the programming instructions. The user interface rendered on the display 1330 may be rendered by programmatically by the graphical user interface 1315.

Hardware system 1300 may include a variety of system architectures and various components of hardware system 1300 may be rearranged. For example, cache 1304 may be on-chip with processor 1302. Alternatively, cache 1304 and processor 1302 may be packed together as a “processor module,” with processor 1302 being referred to as the “processor core.” Furthermore, certain embodiments of the present disclosure may not require nor include all of the above components. For example, the peripheral devices shown coupled to standard I/O bus 1308 may couple to high performance I/O bus 1306. In addition, in some embodiments, only a single bus may exist, with the components of hardware system 1300 being coupled to the single bus. Furthermore, hardware system 1300 may include additional components, such as additional processors, storage devices, or memories.

An operating system manages and controls the operation of hardware system 1300, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft (r) Windows (r) operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. The specification and drawings are, accordingly, to be regarded in an illustrative rather than a restrictive sense. It is, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. In a gaming environment, a method for modifying a computer-implemented avatar, comprising:
rendering a user interface on a display, the user interface including a plurality of modification controls for an avatar;
receiving a user input from a user input device indicating a modification of a skeletal level of the avatar;
implementing, using one or more processors, the modification of the skeletal level based on a blend shaping technique; and
generating an updated display of the avatar.

2. The method of claim 1, wherein the avatar is displayed in an application user interface separate from the edit user interface.

3. The method of claim 1, further comprising:
updating a data structure associated with the avatar in response to detecting the user input from the first modification control,
wherein the data structure comprises a plurality of data nodes, each data node corresponding to a modification control of the plurality of modification controls, and
updating the data structure includes updating a first data node corresponding to the first modification control.

4. The method of claim 1, wherein the generating of the updated display of the avatar is substantially at the same time of the implementing of the modification of the skeletal level of the avatar.

5. The method of claim 1, wherein the generating of the updated display of the avatar is substantially at the same time of the implementing of the modification of the outer surface of the avatar.

6. The method of claim 1, further comprising implementing additive animations to the avatar.

7. The method of claim 1, wherein the blend shaping technique comprises:
generating a first mesh of vertices associated with a skeleton of the avatar;
generating a second mesh of vertices at a different position than the vertices of the first mesh based on the modification of the skeletal level;
mapping the second mesh to the first mesh; and
blending the first mesh and the second mesh to implement a seamless modification of the avatar.

8. The method of claim 1, further comprising:
receiving an additional user input from the user input device indicating a modification of an outer surface of the avatar; and
implementing the modification of the outer surface based on casting and shading techniques.

9. The method of claim 8, wherein the casting and shading techniques comprises:
determining a camera angle based on a mouse input from a user;
determining a UV texture map of the avatar, the UV texture map comprising a plurality of layers, each layer corresponding to a customizable level of the outer surface of the avatar;
applying the modification of the outer surface to the corresponding layer of the UV texture map; and
rendering the avatar based on the modified UV texture map and the camera angle.

10. The method of claim 9, wherein the customizable level comprises a base color tint level, a base texture level, a decal level, an overlay pattern level, or a 3-D painting level.

11. A system for modifying an avatar, comprising:
a display module configured to render a user interface on a display, the user interface including a plurality of modification controls for an avatar; and
a processor-implemented avatar creation module configured to:
receive a user input from a user input device indicating a modification of a skeletal level of the avatar;
implement the modification of the skeletal level based on a blend shaping technique; and
generate an updated display of the avatar.

12. The system of claim 11, wherein the avatar creation module is further configured to:
update a data structure associated with the avatar in response to detecting the user input from the first modification control,
wherein the data structure comprises a plurality of data nodes, each data node corresponding to a modification control of the plurality of modification controls, and
updating the data structure includes updating a first data node corresponding to the first modification control.

13. The system of claim 11, wherein the blend shaping technique comprises:
generating a first mesh of vertices associated with a skeleton of the avatar;
generating a second mesh of vertices at a different position than the vertices of the first mesh based on the modification of the skeletal level;
mapping the second mesh to the first mesh; and
blending the first mesh and the second mesh to implement a seamless modification of the avatar.

14. The system of claim 11, wherein the avatar creation module is further configured to:
receive an additional user input from the user input device indicating a modification of an outer surface of the avatar; and
implement the modification of the outer surface based on casting and shading techniques.

15. The system of claim 14, wherein the casting and shading techniques comprises:
determining a camera angle based on a mouse input from a user;
determining a UV texture map of the avatar, the UV texture map comprising a plurality of layers, each layer corresponding to a customizable level of the outer surface of the avatar;
applying the modification of the outer surface to the corresponding layer of the UV texture map; and
rendering the avatar based on the modified UV texture map and the camera angle.

16. The system of claim 11, wherein the avatar creation module is configured to generate the updated display of the avatar at substantially the same time of the implementation of the modification of the skeletal level of the avatar and at substantially the same time of the implementation of the modification of the outer surface of the avatar.

17. A non-transitory computer-readable storage medium configured to store instructions executable by a processing device, wherein execution of the instructions causes the processing device to implement a method comprising:
rendering a user interface for display, the user interface including a plurality of modification controls for an avatar;
receiving a user input from a user input device indicating a modification of a skeletal level of the avatar;
implementing the modification of the skeletal level based on a blend shaping technique; and
generating an updated display of the avatar.

18. The non-transitory computer-readable storage medium of claim 17, wherein the blend shaping technique comprises:
generating a first mesh of vertices associated with a skeleton of the avatar;
generating a second mesh of vertices at a different position than the vertices of the first mesh based on the modification of the skeletal level;
mapping the second mesh to the first mesh; and
blending the first mesh and the second mesh to implement a seamless modification of the avatar.

19. The non-transitory computer-readable storage medium of claim 17, further comprising:
receiving an additional user input from the user input device indicating a modification of an outer surface of the avatar; and
implementing the modification of the outer surface based on casting and shading techniques.

20. The non-transitory computer-readable storage medium of claim 19, wherein the casting and shading techniques comprises:
determining a camera angle based on a mouse input from a user;
determining a UV texture map of the avatar, the UV texture map comprising a plurality of layers, each layer corresponding to a customizable level of the outer surface of the avatar;
applying the modification of the outer surface to the corresponding layer of the UV texture map; and
rendering the avatar based on the modified UV texture map and the camera angle.
